(19) United States
(12) Patent Application Publication
(10) Pub. No.: US 2024/0380955 A1
(43) Pub. Date: Nov. 14, 2024

(54) APPARATUS AND METHOD FOR MULTISPECTRAL FUSION OF IMAGES, COMBINING IMAGES FROM DIFFERENT WAVELENGHTS

(71) Applicant: UAB "YUKON ADVANCED OPTICS WORLDWIDE", Vilnius (LT)

(72) Inventor: Aliaksandr Alsheuski, Vilnius (LT)

(21) Appl. No.: 18/692,260

(22) PCT Filed: Sep. 14, 2021
(86) PCT No.: PCT/IB2021/058349

§ 371 Date: Mar. 14, 2024

(51) Int. Cl. H04N 23/12; G06T 5/50; H04N 23/11; H04N 23/58

(52) U.S. Cl. CPC H04N 23/12; G06T 5/50; H04N 23/11; H04N 23/58; G06T 2207/10048; G06T 2207/20221

(57) ABSTRACT

The present invention presents an optical apparatus for multispectral fusion of images, comprising two optical channels, operating in different wavelengths. Each of the optical channels comprises a lenses system and an image acquisition sensor. One of the optical channels further comprises a positioning sensing unit. Either the image acquisition sensor or the lenses system is movable, the movement is converted into the electrical signal by the positioning sensing unit. The electrical signal is used to calculate the distance between the optical apparatus and the target object. The positioning sensing unit could comprise a magnet and a magnetic sensor, or could comprise an ultrasonic sensor, an optical sensor, a capacitive sensor, or a rheostat. The images, received from two optical channels from different wavelengths, are combined together and a single fused image is obtained.

### FIELD OF THE INVENTION

The present invention, in general, relates to the optical systems and devices. In particularly, this invention presents a method and an apparatus for multispectral fusion binoculars.

### DISCUSSION OF BACKGROUND ART

Different optical channels, operating in different wavelength, have their own advantages and drawbacks. For example, night vision systems rely on image intensification sensors for the visible/near-infrared wavelength (approximately 400 nm to approximately 900 nm). These devices are capable to capture visible or near infrared light and in some cases intensifying it. A drawback to night vision system is a lack of sensitivity in very low light conditions, and in such conditions as smoke, fog, rain.

Thermal imaging system allows to see objects because they emit thermal energy. These devices operate by capturing the long-wave infrared (LWIR) emission, which is emitted as heat by objects. Hotter objects, such as warm bodies, emit more of this wavelength than cooler objects like trees or ground. Such infrared sensors are not depended on ambient light and are less affected by smoke, fog or dust. However, such sensors do not have sufficient resolution to provide acceptable imagery of the scene.

Therefore, fusion systems of different wavelength could be a solution to get a combined image with improved details. Fusion systems are being developed to combine visible and near-infrared images with LWIR images. Images from two cameras are fused together to provide a fused image that provides benefits of thermal sensing and visualising the fine details from the surroundings.

In a combined wavelength fusion technology, in order to get a clear fused image, it is necessary to obtain the distance of an object. The distance information of the target object could be mechanically aligned by focusing a knob, could be detected by an active rangefinder or by other means. When the distance of an object is known, the images of different wavelength could be fused together in a clear mode.

Patent document CN104931011A (published on 2015 Sep. 23) discloses a passive distance measuring method of an infrared thermal imager. The voltage value output of the focusable infrared thermal imager determines a target object distance. However, focusing infrared lens is quite an impractical method, the camera becomes more complicated.

Patent EP1811771B1 (published on 2009 Apr. 29) discloses a camera that can capture a visible light image and an infrared image of a target scene. Both images are fused together. The camera includes a focusable infrared lens and a display. The focusing of an images is done by moving the infrared lens. However, the method has several drawbacks: making a camera with focusable, moving infrared lens is quite an impractical and expensive method.

Patent document WO2020211576A1 (published on 2020 Oct. 22) discloses a method and device used for dual wavelength fusion. The distance to a target object is determined by moving an objective lens of a thermal imager, the thermal imager obtains the first radial distance that represents the amount of movement of the objective lens. However, the method also has drawbacks: making a camera with movable objective infrared lens is quite an impractical and expensive method, the camera becomes more complicated.

Our proposed method and the apparatus, based on this method, avoids disadvantages of the above-described methods, and presents several alternative possibilities for measuring the distance between the optical apparatus and the target object with an improved method. When the distance is known, images from different wavelength could be combined finely.

### SUMMARY OF THE INVENTION

The present invention presents an optical apparatus for multispectral fusion of images, comprising two optical channels, operating in different wavelength. Each of the optical channels comprises a lenses system and an image acquisition sensor. One of the optical channels further comprises a positioning sensing unit. Either the image acquisition sensor or the lenses system are movable, the movement generates an electrical signal. The electrical signal is used to calculate the distance between the optical apparatus and the target object. The positioning sensing unit could be located either in the first optical channel, in the second optical channel or in both optical channels. The m positioning sensing unit could be a contactless or with a rigid connection. The positioning sensing unit could comprise a magnet and a magnetic sensor. The positioning sensing unit could also comprise an ultrasonic sensor, an optical sensor, a capacitive sensor, or a rheostat. The images, received from two optical channels from different wavelengths, are combined together and a single fused image is obtained. When the first optical channel operates at the visible or near-infrared wavelength, and the second optical channel operates at the long-wave infrared (LWIR) wavelength, suitable for a thermal imaging of alive objects, a fused image is obtained, which combines these two images with fine details from both wavelength.

### BRIEF DESCRIPTION OF THE DRAWINGS

FIG. 1. presents the challenge of fusing two images from two cameras.

There: O—target object, 1—first optical channel, 2—second optical channel, Im1—image 1, Im2—image 2, Im3—image 3, Im4—image 4.

FIG. 2. presents the optical apparatus, when the optical channel comprises the stationary lenses system (10) and the movable image acquisition sensor (20). There: 3—positioning sensing unit, 8—magnet. The black arrows show the movement of the optical channel's movable components.

### DETAILED DESCRIPTION OF THE INVENTION

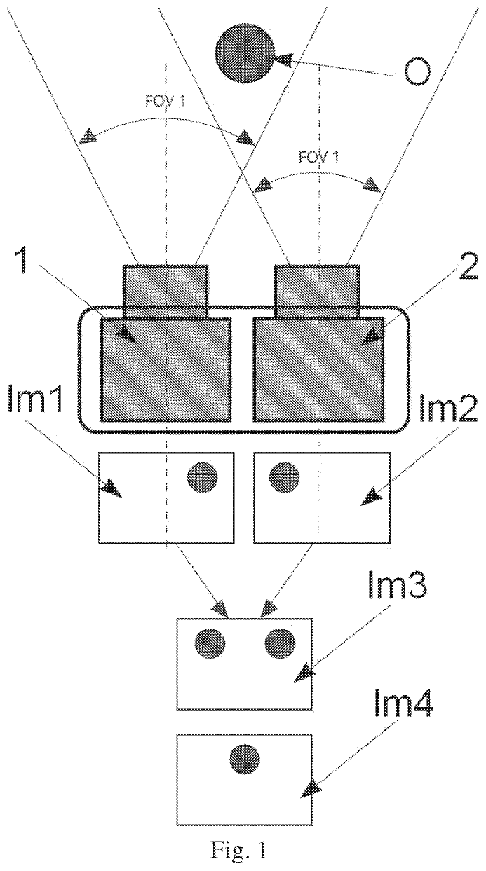

The present invention discloses an optical apparatus for multispectral fusion of images. It is a binocular, which has two different optical channels. When two cameras, operating in different spectrum parts, are combined into one optical apparatus having one housing, the different images could not be simply fused because the images do not overlap. FIG. 1 presents the challenge of fusing two images from different wavelength. If the images from different spectrum parts are fused without adjustment of the images, a double vision effect would be produced. There is one target object (O). A first optical channel (1), operating in a particular spectrum part, records a first image (Im1). A second optical channel (2), operating in a different spectrum part, records second image (Im2). If these two images (Im1 and Im2) are simply fused together, a blurred image (Im3) would be generated as a result. Therefore, the images (Im1 and Im2) have to be calibrated. The scope of the optical apparatus is to receive a clear fused image (Im4), which would fuse two images (Im1 and Im2) together. The present invention discloses an optical apparatus and a method, suitable for multispectral fusion of images, when a single, clear image (Im4) is generated as a result.

The optical apparatus of the present invention comprises:
a first optical channel (1);
a second optical channel (2);
a positioning sensing unit (3)

In addition, the optical apparatus could comprise other components, necessary for the proper functioning: a casing, a processor, a battery, a viewfinder, a mechanical mount between the optical channels and other.

Each of the optical channels (1 and 2) comprise the lenses system (10) and the image acquisition sensor (20). The lenses system (10) is a set of lenses, which transmit the electromagnetic emission and are used for focusing it. The lenses system (10) of the present invention has at least one lens. When there are several lenses, all of them are arranged into a common optical axis. After the electromagnetic emission passes through the lenses system (10) and is focused, the focused electromagnetic emission reaches the image acquisition sensor (20).

The image acquisition sensor (20) is used to capture the image produced by the lenses system (10). The image acquisition sensor (20) generates an image of a target object (O). Both the lenses system (10) and the image acquisition sensor (20) could be either stationary or movable. When the lenses system (10) and the image acquisition sensor (20) are movable, they move along the optical axis of the optical channel.

As shown in FIG. 1, since the optical channels are located distantly from each other, thus the two images from different optical channels (Im1 and Im2) could not be fused by simply merging them, because the outcome image (Im3) would be blurred. For a fine combination of images from different wavelength, the distance between the optical apparatus and the target object (O) must be known. In the present invention, either the lenses system (10) or the image acquisition sensor (20) is movable along the common optical axis, so the distance from the lens system (10) to the image acquisition sensor (20) could be calculated. The amount of displacement of the lenses system (10) or the image acquisition sensor (20) of at least one optical channel is proportional to the distance from the optical apparatus to the target object (O). The positioning sensing unit (3) is a unit, which converts the movement of the lenses system (10) or the image acquisition sensor (20) into an electrical signal. This electrical signal is used to calculate the distance from the optical apparatus to the target object (O). The positioning sensing unit (3) could be located in the first optical channel (1), in the second optical channel (2) or in both optical channels.

The positioning sensing unit (3) could be any device, which has a sensor, capable of detecting the movement of the lenses system (10) or the image acquisition sensor (20) and converting the movement into the electrical signal. The positioning sensing unit (3) could be a device, having a contact with any of the optical channels (1 or 2), or it could be a contactless device. There could be different types of sensors. The positioning sensing unit (3) could comprise a magnetic sensor and a magnet (8). The positioning sensing unit (3) could comprise an ultrasonic sensor, an optical sensor, a capacitive sensor, or any other sensor, suitable for converting the movement of the lenses system (10) or the image acquisition sensor (20) into the electrical signal.

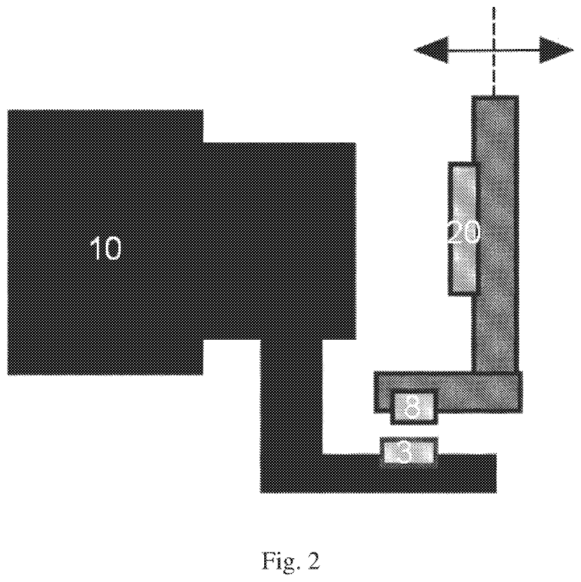

When the positioning sensing unit (3) comprise a magnetic sensor and a magnet (8), the contactless magnetic sensor measures magnetic field changes (FIG. 2). The contactless magnetic sensor could be a Hall sensor, which can detect the magnetic field changes in the optical channel. The magnet (8) is used to produce a magnetic field. When the lenses system (10) or the image acquisition sensor (20) moves in relation to each other, the magnetic field changes. In FIG. 2, the direction of movement of the image acquisition sensor (20) is shown by black arrows. The changes in the magnetic field are detected by the positioning sensing unit (3), in this case—the contactless magnetic sensor.

When the positioning sensing unit (3) comprise the contactless ultrasonic sensor, the contactless ultrasonic sensor uses an ultrasound to detect the movement of the lenses system (10) or the image acquisition sensor (20) in the optical channel. The contactless ultrasonic sensor could be located close to the lenses system (10) or close the image acquisition sensor (20). FIG. 2 shows the case, when the contactless ultrasonic sensor is located close to the image acquisition sensor (20), which is movable. When the contactless ultrasonic sensor is located close to the lenses system (10), it is orientated towards the image acquisition sensor (20) and vice versa. The time, needed for the ultrasound to reach the ultrasonic sensor, is proportional to the distance between the lenses system (10) and the image acquisition sensor (20).

Alternatively, the positioning sensing unit (3) could comprise a contactless optical sensor, used to detect the movement of the lenses system (10) or the image acquisition sensor (20) in the optical channel. As in the case with ultrasound, the contactless optical sensor could be located close to the lenses system (10) or close the image acquisition sensor (20). When the contactless optical sensor is located close to the lenses system (10) (FIG. 2), it is orientated towards the image acquisition sensor (20) and vice versa. The contactless optical sensor detects the optical signal. The time, needed for the optical signal to reach the optical sensor, is proportional to the distance between the lenses system (10) and the image acquisition sensor (20).

The positioning sensing unit (3) could also comprise the contactless capacitive sensor. In this case, the capacitive sensor measures the capacity in the optical channel, which is proportional to the distance between the lenses system (10) and the image acquisition sensor (20).

In another case, the positioning sensing unit (3) could comprise a rheostat (7), present in one of the optical channels. The rheostat (7) is a variable resistor, which controls electric current changes in the optical channel. The movement of the lenses system (10) or the image acquisition sensor (20) leads to the changes of the electric current, which is detected by the rheostat (7).

In addition, the positioning sensing unit (3) could comprise other types of sensors, suitable for detection of the movement of the lenses system (10) or the image acquisition sensor (20), and which are able to convert this movement into the electrical signal.

There are several alternatives, how the components of the optical apparatus are connected in relation to each other. The optical apparatus could have a different combination of the components—some of the components of the optical channel could be movable, while other components are stationary. Either the first optical channel (1) or the second optical channel (2) could comprise movable components and a positioning sensing unit (3). First, the movable components could be the lenses system (10) or the image acquisition sensor (20) in one of the optical channels.

Second, both optical channels could comprise a movable components and the positioning sensing unit (3).

Third, neither of optical channels do not comprise a positioning sensing unit (3), and all components of the optical channels are stationary. In this case, there are several alternatives:
the optical apparatus further comprises an active rangefinder (4);
artificial intelligence device (5) is used to analyze patterns in the images in order to fuse the images correctly;
the optical apparatus further comprises an optical apparatus focusing knob (6), which is connected to both optical channels and allows to fuse the images correctly without measuring the distance from the optical apparatus to the target object.

These alternative compositions of the optical apparatus are listed below.

### Embodiments of the Optical Apparatus Composition

In the preferred embodiment of the present invention, the optical apparatus comprises two optical channels, and one of the optical channels comprises the movable image acquisition sensor (20) (FIG. 2). In this case, the first optical channel (1) comprises the stationary lenses system (10), the movable image acquisition sensor (20) and the positioning sensing unit (3). The second optical channel (2) comprises the stationary lenses system (10) and the stationary image acquisition sensor (20). The positioning sensing unit (3), located in the first optical channel (1), converts the movement of the lenses system (10) or the image acquisition sensor (20) into the electrical signal. The electrical signal of the positioning sensing unit (3) is used to calculate the distance from the optical apparatus to the target object (O). The distance from the optical apparatus to the target object (O) could be measured using the magnetic sensor, the ultrasonic sensor, the optical sensor, the capacitive sensor or other suitable sensor. The sensors could be contactless or could have a rigid connection with the optical channel.

In another case, the first optical channel (1) comprises the stationary lenses system (10) and the stationary image acquisition sensor (20). The second optical channel (2) comprises the stationary lenses system (10), the movable image acquisition sensor (20) and the positioning sensing unit (3) (FIG. 2). The difference from the embodiment above is that the positioning sensing unit (3) is located in the second optical channel (2). As an example, such optical apparatus could be used for combining the night vision image and the thermal image. In this case, the first optical channel (1) is operating at the visible wavelength, and the second optical channel (2) is operating at the upper portion of the infrared wavelength and is used for the thermal imaging.

So, the distance between the optical apparatus to the target object (O) could be measured using either the first optical channel (1), operating in the visible wavelength; or using the second optical channel (2), operating in the infrared wavelength, used for the thermal imaging.

In another embodiment of the present invention, the optical apparatus comprises two optical channels, and one of the optical channels comprises the movable lenses system (10). In this case, the first optical channel (1) comprises the movable lenses system (10), the stationary image acquisition sensor (20) and the positioning sensing unit (3). The second optical channel (2) comprises the stationary lenses system (10) and the stationary image acquisition sensor (20). The positioning sensing unit (3), located in the first optical channel (1), converts the movement of the lenses system (10) or the image acquisition sensor (20) into the electrical signal. The movement is proportional to the distance from the optical apparatus to the target object (O). As disclosed above, the positioning sensing unit (3) could be any kind of sensor, suitable for detecting changes in the movement of the lenses system (10).

In another case, the first optical channel (1) comprises the stationary lenses system (10) and the stationary image acquisition sensor (20). The second optical channel (2) comprises the movable lenses system (10), the stationary image acquisition sensor (20) and the positioning sensing unit (3). When the first optical channel (1) operates at the visible wavelength, and the second optical channel (2) operates at the upper portion of the infrared wavelength and is used for the thermal imaging, the distance between the optical apparatus and the target object could be measured using either the first optical channel (1) or the second optical channel (2) by moving the lenses system (10).

In the fifth embodiment of the present invention, the optical apparatus comprises two optical channels, and both of them have the positioning sensing unit (3).

In one case, the image acquisition sensors (20) of both optical channels are used to measure the distance. The first optical channel (1) comprises the stationary lenses system (10), the movable image acquisition sensor (20) and the positioning sensing unit (3). The second optical channel (2) comprises the stationary lenses system (10), the movable image acquisition sensor (20) and the positioning sensing unit (3). In this case the image acquisition sensors (20) of both optical channels move, the movements in both optical channels are detected and are used to calculate the distance between the optical apparatus and the target object (O). In the example of combining the night vision and the thermal vision binocular, the image acquisition sensors (20) of both visible and thermal imaging optical channels are used to measure the distance.

In another case, the movable lenses system (10) of both optical channels are used to calculate the distance. The first optical channel (1) comprises the movable lenses system (10), the stationary image acquisition sensor (20) and the positioning sensing unit (3). The second optical channel (2) comprises the movable lenses system (10), the stationary image acquisition sensor (20) and the positioning sensing unit (3). In this case the lenses systems (10) of both optical channels move, the movements in both optical channels are detected and are used to calculate the distance between the optical apparatus and the target object (O).

In another embodiment of the present invention, the optical apparatus comprises two optical channels, each of them comprising the stationary lenses system (10) and the stationary image acquisition sensor (20), without the positioning sensing unit (3). The optical apparatus further comprises an active rangefinder (4), which is used for measuring the distance from the optical apparatus to the target object (O). The active rangefinder (4) is directed towards the target object and emits an optical radiation from a transmitter. The optical radiation is reflected from the target object (O) and is received with an appropriate receiver. The received optical radiation is then processed by an appropriate processing unit and the distance from the optical apparatus to the target object (O) is calculated.

In another embodiment of the present invention, the optical apparatus comprises two optical channels, each of them comprising the stationary lenses system (10) and the stationary image acquisition sensor (20), without the positioning sensing unit (3). The optical apparatus further comprises an artificial intelligence device (5). Two separate images from different optical channels are obtained without prior measuring the distance from the optical apparatus to the target object (O). The artificial intelligence device (5) analyses patterns in both images, which allows to fuse the images (Im1 and Im2) correctly without measuring the distance from the optical apparatus to the target object (O).

The first optical channel (1) and the second optical channel (2) of the optical apparatus of the present invention operate in different wavelength. In the preferred embodiment of the present invention, the optical apparatus is used for a night vision. The first optical channel (1) is an optical system, suitable for capturing images at the visible or near-infrared wavelength (Im1). The second optical channel (2) operates at the upper portion of the infrared wavelength and captures thermal energy from alive bodies (Im2). A single fused image (Im4) is obtained after fusing of these two types of images (Im1 and Im2).

In another embodiment of the present invention, the first optical channel (1) operates at the visual wavelength, and the second optical channel (2) operates at the ultraviolet (UV) wavelength.

In yet another embodiment of the present invention, the first optical channel (1) operates at the visible wavelength, while the second optical channel (2) operates at the Midwave Infrared (MWIR), Longwave Infrared (LWIR) or Shortwave Infrared (SWIR) wavelength. In principle, the two optical channels of the present optical apparatus could operate at any wavelengths. In addition, the two optical channels of the present optical apparatus could also operate at the same wavelength. When the optical channels operate at different wavelengths, it is a big advantage to get a fused image (Im4) by combining two images (Im1 and Im2) from different wavelength, since each of the vision mode show some details, invisible by the other optical channel. Our invention discloses several alternatives of the optical apparatus composition and several different methods for measuring the distance between the optical apparatus and the target object (O).

A method for multispectral fusion of images from different wavelength comprises the following steps:
movement of the lenses system (10) or the image acquisition sensor (20);
conversion of movement of the lenses system (10) or the image acquisition sensor (20) into the electrical signal;
calculation of the distance from the optical apparatus to the target object;
image of the target object registration through the first optical channel (1);
image of the target object registration through the second optical channel (2);
fusion of the images from both optical channels;
delivery of a single fused image.

### Movement of the Lenses System (10) or the Image Acquisition Sensor (20)

The distance from the optical apparatus to the target object is measured by one of the ways, described above, depending on the optical apparatus composition. Either the lenses system (10) or the image acquisition sensor (20) moves along the common optical axis. The first optical channel (1), the second optical channel (2), or both optical channels could move. Either the lenses system (10) or the image acquisition sensor (20) could be used to generate the electrical signal from the movement. The positioning sensing unit (3) could be a magnetic sensor, an ultrasonic sensor, an optical sensor, or a capacitive sensor, and the positioning sensing unit (3) could detect voltage changes or current changes in the magnetic field, changes in the ultrasound, optical signal changes, or changes in the capacity of the optical channel, accordingly.

### Conversion of Movement of the Lenses System (10) or the Image Acquisition Sensor (20) Into the Electrical Signal

The basic working principle of the present invention is the following: the positioning sensing unit (3) converts the movement of the lenses system (10) or the image acquisition sensor (20) into the electrical signal, and this electrical signal is later used to calculate the distance from the optical apparatus to the target object (O)). The movement is converted into the electrical signal by the positioning sensing unit (3). As described above, the positioning sensing unit (3) could be a magnetic sensor, an ultrasonic sensor, an optical sensor, a capacitive sensor, or could comprise a rheostat. Thus, the electrical signal is generated due to the changes in the magnetic field, ultrasound, optical signal, capacity or electric current, accordingly.

Calculation of the Distance from the Optical Apparatus to the Target Object

The distance from the optical apparatus to the target object (O) is calculated based on the electrical signal, received from the positioning sensing unit (3). The movement of either the lenses system (10) or the image acquisition sensor (20) along the optical axis is proportional to the distance from the optical apparatus to the target object (O). Thus, the electrical signal is also proportional to the distance from the optical apparatus to the target object (O).

There are alternative alternatives, when the optical apparatus does not comprise the positioning sensing unit (3), and the electrical signal is not generated.

When the optical apparatus instead of the positioning sensing unit (3) comprises the rangefinder (4), the distance is measured by transmitting the optical radiation to the target object (O) and receiving the reflected signal from the target object (O)).

### Image of the Target Object Registration Through the First Optical Channel (1)

When the distance from the optical apparatus to the target object (O) is known, the image of the target object (Im1) through the first optical channel (1) is registered. If the optical apparatus comprises the first optical channel (1), operating at the visible wavelength, and the second optical channel (2) is operating at the upper portion of the infrared wavelength, suitable for a thermal imaging of alive objects, the first visual image (Im1) is generated through the first optical channel (1).

### Image of the Target Object Registration Through the Second Optical Channel (2)

Next, the second image (Im2) of the target object (O) through the second optical channel (2) is registered. If the optical apparatus comprises the first optical channel (1), operating at the visible wavelength, and the second optical channel (2) is operating at the upper portion of the infrared wavelength, suitable for a thermal imaging of alive objects, the thermal image (Im2) is obtained through the second optical channel (2).

Fusion of the Images from Both Optical Channels

Two separate images (Im1 and Im2) are fused into a single image (Im4), taking into account the distance from the optical apparatus to the target object. When the two images (Im1 and Im2), received from the first optical channel (1) and the second optical channel (2), are registered, and the distance to the target object (O) is known, the two images (Im1 and Im2) could be combined together. The distance to the target object (O)), the coordinates, size of the field of the vision, other necessary image parameters are calculated, which allows combination of images (Im1 and Im2) into a single fused image (Im4). Without knowing the distance from the optical apparatus to the target object, two separate, not overlapping images (Im3) would be obtained.

When the optical apparatus comprises the artificial intelligence device (5), the distance from the optical apparatus to the target object is not measured at all. Two separate images from different optical channels are registered. The artificial intelligence device (5) analyses patterns in both images, which allows to fuse the images (Im1 and Im2) correctly without measuring the distance from the optical apparatus to the target object (O).

When the optical apparatus instead of the positioning sensing unit (3), comprises an optical apparatus focusing knob (6), which is connected to both optical channels (1 and 2), the optical channels (1 and 2) are aligned mechanically. This allows to fuse the images correctly without measuring the distance from the optical apparatus to the target object (O).

### Delivery of a Single Fused Image

When the distance from the optical apparatus to the target object (O) is known, a single fused image (Im4) is generated from at least two images (In) and Im2) from different wavelength. The single fused image (Im4) is generated by overlapping the corresponding field of view from the different wavelength. In another embodiment of the present invention, a single fused image (Im4) could be generated by fusing two images (Im1 and Im2) from the same wavelength. The fused image (Im4) is clear, not blurred and overlap precisely. The advantage of such fused image (Im4) is that the image contains fine details and could detect alive object in poor visual conditions, such as fog, smoke etc.

The first optical channel (1), the second optical channel (2) and the positioning sensing unit (3) operate in a real time mode, therefore the fused image (Im4) is generated dynamically in a real time.

In order to illustrate and describe the invention, the description of the preferred embodiments is presented above. This is not a detailed or restrictive description to determine the exact form or embodiment. The above description should be viewed more than the illustration, not as a restriction. It is obvious that specialists in this field can have many modifications and variations. The embodiment is chosen and described in order to best understand the principles of the present invention and their best practical application for the various embodiments with different modifications suitable for a specific use or implementation adaptation.

What is claimed is:

1. An optical apparatus for multispectral fusion of images, comprising:
a first optical channel, comprising a lenses system and an image acquisition sensor;
a second optical channel, comprising the lenses system and the image acquisition sensor; characterized in that:
the lenses system or the image acquisition sensor, located in any of the optical channels, are movable;
the optical apparatus further comprises a positioning sensing unit, which detects the movement of the lenses system or the image acquisition sensor and converts the movement into the electrical signal;
the first optical channel and the second optical channel operate in different wavelength; and the electrical signal is used to calculate the distance from the optical apparatus to the target object, which allows to fuse the images from different wavelengths.

2. The optical apparatus according to the claim 1, characterized in that:
the first optical channel comprises the stationary lenses system, the movable image acquisition sensor and the positioning sensing unit;
the second optical channel comprises the stationary lenses system and the stationary image acquisition sensor;
thus, the distance from the optical apparatus to the target object is calculated from the movement of the image acquisition sensor of the first optical channel.

3. The optical apparatus according to the claims 1-2, characterized in that:
the first optical channel comprises the stationary lenses system and the stationary image acquisition sensor;
the second optical channel comprises the stationary lenses system, the movable image acquisition sensor and the positioning sensing unit;
thus, the distance from the optical apparatus to the target object is calculated from the movement of the image acquisition sensor of the second optical channel.

4. The optical apparatus according to the claims 1-3, characterized in that:
the first optical channel comprises the movable lenses system, the stationary image acquisition sensor and the positioning sensing unit;
the second optical channel comprises the stationary lenses system and the stationary image acquisition sensor;
thus, the distance from the optical apparatus to the target object is calculated from the movement of the lenses system of the first optical channel.

5. The optical apparatus according to the claims 1-4, characterized in that:
the first optical channel comprises the stationary lenses system and the stationary image acquisition sensor;
the second optical channel comprises the movable lenses system, the stationary image acquisition sensor and the positioning sensing unit;
thus, the distance from the optical apparatus to the target object is calculated from the movement of the lenses system of the second optical channel.

6. The optical apparatus according to the claims 1-5, characterized in that:
the first optical channel comprises the stationary lenses system, the movable image acquisition sensor and the positioning sensing unit;
the second optical channel comprises the stationary lenses system, the movable image acquisition sensor and the positioning sensing unit;
thus, the distance from the optical apparatus to the target object is calculated from the movements of the image acquisition sensor of both optical channels.

7. The optical apparatus according to the claims 1-6, characterized in that:
the first optical channel comprises the movable lenses system, the stationary image acquisition sensor and the positioning sensing unit);
the second optical channel comprises the movable lenses system, the stationary image acquisition sensor and the positioning sensing unit;
thus, the distance from the optical apparatus to the target object is calculated from the movements of the lenses system of both optical channels

8. (canceled)

9. (canceled)

10. (canceled)

11. The optical apparatus according to the claims 1-10, characterized in that the positioning sensing unit comprises a magnet and a magnetic sensor.

12. The optical apparatus according to the claims 1-11, characterized in that the positioning sensing unit comprises an ultrasonic sensor.

13. The optical apparatus according to the claims 1-12, characterized in that the positioning sensing unit comprises an optical sensor.

14. The optical apparatus according to the claims 1-13, characterized in that the positioning sensing unit comprises a capacitive sensor.

15. The optical apparatus according to the claims 1-14, characterized in that the positioning sensing unit comprises a rheostat.

16. The optical apparatus according to the claims 1-15, characterized in that the first optical channel operates at the visible wavelength, and the second optical channel operates at the longwave infrared (LWIR) wavelength.

17. A method for the fusion of images from different wavelengths obtained through two optical channels, characterized in that the method comprises the following steps:
movement of the lenses system or the image acquisition sensor;
conversion of movement of the lenses system or the image acquisition sensor into the electrical signal;
calculation of the distance from the optical apparatus to the target object;
image of the target object registration through the first optical channel;
image of the target object registration through the second optical channel;
fusion of the images from both optical channels;
delivery of a single fused image.

18. The method for fusion of images from different wavelength according to the claim 17, characterized in that the fused image is generated dynamically in a real time mode.
